(19) United States
(12) Patent Application Publication
(10) Pub. No.: US 2004/0046755 A1
(43) Pub. Date: Mar. 11, 2004

(54) Display units and their fabrication methods

(76) Inventors: Makoto Okai, Tokorozawa (JP); Takahiko Muneyoshi, Musashimurayama (JP); Tomio Yaguchi, Sagamihara (JP); Nobuaki Hayashi, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/361,629

(22) Filed: Feb. 11, 2003

(30) Foreign Application Priority Data
Aug. 8, 2002 (JP) 2002-230908

(51) Int. Cl. G09G 5/00

(52) U.S. Cl. 345/204

(57) ABSTRACT

There are realized display units which can increase the emitting point density of nanotube electron emitters as electron emitters and have a good image quality and their fabrication methods.

In nanotube electron emitters forming electron emitters 403, nanotubes 102 and granular support media 103 composed of an electric conductor are mixed with each other, at least one end of the nanotubes 102 and the support media 103 are adhered onto a substrate by melted metal adhesives 104, and the other end of the nanotubes 102 is oriented as a free end in the vertical direction to the substrate by the support action of the support media 103. This can increase the emitting point density of the electron emitters from below 1000 points/cm² in a prior art to above 100000 points/cm². An in-plane uniform emitting pattern enough to make practical use of emissive type flat-panel display units can be realized.

### BACKGROUND OF THE INVENTION

1. Field of the Invention

The present invention relates to display units and their fabrication methods. More specifically, the present invention relates to display units having a function which uses nanotube electron emitters as electron emitters to illuminate phosphor layers, displaying image information on a panel and their fabrication methods.

2. Description of the Related Art

Nanotube electron emitters as electron emitters having carbon, boron and nitrogen as constituents are known. A carbon nanotube electron emitter having carbon as a constituent will be described here as a representative example.

There have been reported many carbon nanotube electron emitters and emissive type flat-panel display units using the same as electron emitters. An example in which a 4.5-inch emissive type flat-panel display unit is fabricated is described in SID 99 Digest pp. 1134-1137. The emissive type of the emissive type flat-panel display unit illuminates phosphor layers provided on an image display panel by irradiating an excitation light such as an electron beam or an ultraviolet light to display an image. It is distinguished from an LCD (Liquid Crystal Display) which is not emissive.

In the prior art method described in the document, a paste for forming carbon nanotube electron emitters includes a glass-constituent as an adhesive.

The glass constituent as an adhesive remains as glass of an electrical insulation material when the paste is heat treated. The percentage of the electrically connected carbon nanotubes is at most several ten % at a micro-level. The emitting point density is below 1000 points/cm². The emitting in-plane uniformity is very low.

The low emitting point density means that the electron beam emitting density of the electron emitters for exciting the phosphor layers is low, resulting in nonuniformity. The screen is dark and the displayed image is not uniform, thereby deteriorating the image quality significantly. The problem will be serious as the image display panel is larger to increase the displayed area.

### SUMMARY OF THE INVENTION

To solve the above prior art problems, an object of the present invention is to provide display units which can increase the emitting point density of nanotube electron emitters as electron emitters and have a good image quality and their fabrication methods.

To achieve the above object, the present inventors have experimented and studied various fabrication methods which can increase the characteristic of nanotube electron emitters as electron emitters of display units and can easily obtain-electron emitters having a high reliability. We have obtained findings that high-performance nanotube electron emitters can be obtained by industrially easy fabrication methods to realize excellent display units.

The present invention has been made based on such important findings. In summary, a low melting point metal material, not glass, is used as an adhesive in a paste containing nanotubes to secure complete electric conduction at a micro-level, thereby reliably securing electric conduction of the nanotubes and the electrode base material.

This can increase the emitting point density above 100000 points/cm². An in-plane uniform emitting pattern can be realized.

The nanotubes targeted by the present invention are single-wall nanotubes of a single-layer tubular structure composed of at least one of elements of carbon, boron and nitrogen or multiwall nanotubes of a nesting-like multilayer tubular structure.

### BRIEF DESCRIPTION OF THE DRAWINGS

FIG. 1 is an explanatory view of Embodiment 1 of the present invention;

FIG. 2 is an explanatory view of Embodiment 2 of the present invention;

FIG. 3 is an explanatory view of Embodiment 2 of the present invention;

FIG. 4 is an explanatory view of Embodiment 2 of the present invention;

FIG. 5 is an explanatory view of Embodiment 2 of the present invention;

FIG. 6 is an explanatory view of Embodiment 2 of the present invention;

FIG. 7 is an explanatory view of Embodiment 2 of the present invention;

FIG. 8 is an explanatory view of Embodiment 2 of the present invention;

FIG. 9 is an explanatory view of Embodiment 2 of the present invention;

FIG. 10 is an explanatory view of Embodiment 3 of the present invention;

FIG. 11 is an explanatory view of Embodiment 3 of the present invention;

FIG. 12 is an explanatory view of Embodiment 3 of the present invention;

FIG. 13 is an explanatory view of Embodiment 3 of the present invention; and

FIG. 14 is an explanatory view of Embodiment 3 of the present invention.

### DESCRIPTION OF THE PREFERRED EMBODIMENTS

The features of the present invention will be described below more specifically.

In a first invention of the present invention, a display unit having:

an electron emitter substrate having nanotube electron emitters as electron emitters, the electron emitters being formed in a matrix form in the crossing parts of scan lines and signal lines;

an image display panel having a phosphor screen having phosphor layers and an anode electrode arranged by forming a space at a predetermined pitch opposite the electron emitter substrate; and

a control part transmitting image information to the image display panel to display an image, wherein

in the nanotube electron emitters forming electron emitters, nanotubes and granular support media composed of an electric conductor are mixed with each other, at least one end of the nanotubes and the support media are adhered onto the substrate by melted metal adhesives, and the other end of the nanotubes is oriented as a free end in the vertical direction to the substrate by the support action of the support media.

In a second invention, the granular support media are composed of a granular electric conductor not dissolved at the melting adhesion temperature of the metal adhesives. As the preferable granular electric conductor, at least one granular electric conductor selected from the group of C, Ag, Au, Pt, Pd, Ni, Fe, Cu and Co is given.

In a third invention, the metal adhesives include at least one metal selected from the metal group of Sn, Pb, Bi, In, Cd, Zn, Ag and Al.

In a fourth invention, the nanotubes include single-wall nanotubes of a single-layer tubular structure composed of at least one element of carbon, boron and nitrogen. Preferably, the single-wall nanotubes have an average length of 0.5 to 2.0 microns.

In a fifth invention, the nanotubes include multiwall nanotubes of a nesting-like multilayer tubular structure composed of at least one element of carbon, boron and nitrogen.

In a sixth invention, the single-wall nanotubes are nanotubes having an average length of 0.5 to 2.0 microns. Preferably, the multiwall nanotubes have an average length of 0.5 to 5.0 microns.

In a seventh invention, a fabrication method of the display unit having:

a step of fabricating an electron emitter substrate having nanotube electron emitters as electron emitters, the electron emitters being formed in a matrix form in the crossing parts of scan lines and signal lines;

a step of fabricating a phosphor screen having phosphor layers and an anode electrode arranged by forming a space at a predetermined pitch opposite the electron emitter substrate; and

an assembling step for fixing the electron emitter substrate and the phosphor screen via a frame, wherein

the step of fabricating nanotube electron emitters forming electron emitters includes the steps of: preparing a paste including nanotubes, granular support media composed of an electric conductor, metal adhesives, and organic compounds for pasting; forming a nanotube electron emitter pattern by printing or coating the paste onto the substrate; and heat treating the same.

Embodiments

Embodiments of the present invention will be described below specifically according to the drawings.

<Embodiment 1>

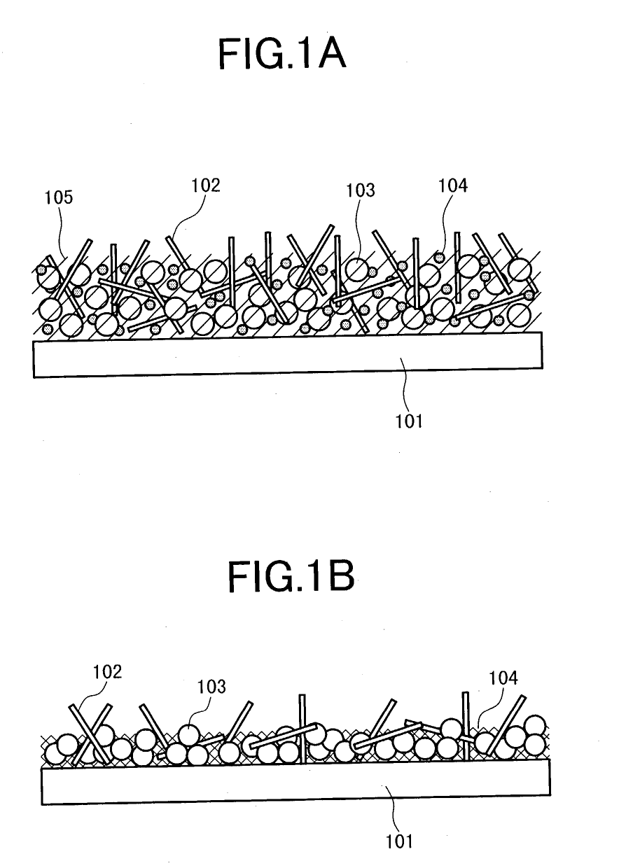

Embodiment 1 of the present invention will be described using FIG. 1 and Table 1. FIG. 1(a) schematically shows the state of a nanotube paste printed or coated onto a glass substrate 101. The nanotube paste includes nanotubes 102, support media 103, metal adhesives 104 and organic compounds 105.

The nanotubes 102 are used as electron emitters. The nanotubes have a diameter of about 0.7 to 50 nm and a length of 0.5 to several ten microns. Because of their very long and narrow structures, an electric field concentrates on their edges. It is possible to obtain an emitting current density enough to realize an emissive type flat-panel display unit of several ten mA/cm² with a very low electric field of several V/micron.

A single-layer nanotube is called a single-wall nanotube. A multilayer nanotube in which single walls are of a concentric nesting structure is called a multiwall nanotube.

The present invention can use either the single-wall nanotube and the multiwall nanotube. The present invention can also use a composite thereof. A nanotube composed of a carbon atom is called a carbon nanotube. Other than the carbon nanotube, a nanotube composed of boron and nitrogen elements is also known.

A nanotube can be composed of three elements of carbon, boron and nitrogen. The present invention can also use a nanotube composed of every element.

The support media 103 are made of a granular material as an electric conductor and are used for orienting the nenotubes 102 in the vertical direction to the substrate 101. When the later-described metal adhesives 104 are melted to adhere the nanotube 102, the support media 103 must hold their granular shape without being dissolved. When the length of the nanotubes 102 is about 1 micron, the size of the support media 103 is also desirably about 1 micron.

Desirable is the material of the support media 103 which is hard to form an oxide on the surface. Otherwise, desirable is the material of the support media 103 in which an oxide is conductive. It is possible to use a metal such as Ag, Au, Pt, Pd, Ni, Fe, Cu and Co or an alloy thereof. It is also possible to use graphite and spherical graphite.

When the nanotube paste is heat treated, the metal adhesives 104 adhere the nanotubes 102 and the support media 103 onto the substrate 101 and are used to secure electric conduction of the nanotubes 102 and the support media 103. Low melting point metal particles can be used as the metal adhesives 104. Examples of low melting point metals and alloys thereof are shown in Table 1.

TABLE 1

| | Melting | | | | | | | | |
|---|---|---|---|---|---|---|---|---|---|
| | temperature | | | | | | | | |
| No. | (° C.) | Sn | Pb | Bi | In | Cd | Zn | Ag | Al |
| 1 | 57.8 | 12 | 18 | 49 | 21 | | | | |
| 2 | 78.9 | 17 | | 57 | 26 | | | | |
| 3 | 95 | 15.5 | 32 | 52.5 | | | | | |
| 4 | 100 | 22 | 28 | 50 | | | | | |
| 5 | 134.2 | 37.5 | 37.5 | | 25 | | | | |
| 6 | 182 | | 50 | | 50 | | | | |
| 7 | 183 | 61.9 | 38.1 | | | | | | |
| 8 | 183 | 63 | 37 | | | | | | |
| 9 | 183 | 60 | 40 | | | | | | |
| 10 | 183 | 55 | 45 | | | | | | |
| 11 | 183 | 50 | 50 | | | | | | |
| 12 | 183 | 45 | 55 | | | | | | |
| 13 | 183 | 40 | 60 | | | | | | |
| 14 | 176 | 25 | | | | 75 | | | |
| 15 | 266 | | | | | 82.5 | 17.5 | | |
| 16 | 300 | 5 | 95 | | | | | | |
| 17 | 304 | | 97.5 | | | | | 2.5 | |
| 18 | 419 | | | | | | 100 | | |
| 19 | 382 | | | | | | 95 | | 5 |
| 20 | 200 | 91 | | | | | 9 | | |
| 21 | 200 | 70 | | | | | 30 | | |
| 22 | 200 | 60 | | | | | 40 | | |
| 23 | 200 | 30 | | | | | 70 | | |
| 24 | 265 | | | | | 10 | 90 | | |
| 25 | 265 | | | | | 40 | 60 | | |
| 26 | 171 | 34 | 63 | | | | 3 | | |

Table 1 shows compositions of the metals and their melting temperatures. It is possible to use a metal such as Sn, Pb, Bi, In, Cd, Zn, Ag and Al and an alloy thereof.

The organic compounds 105 are used as a solvent for pasting. In consideration of printability or coatability, various organic compounds 105 can be used.

As an example of the nanotube paste composition, the nanotube paste is prepared using multiwall nanotubes having an average diameter of 20 nm and an average length of 1 micron as the nanotubes 102, silver fine grains having an average diameter of 1 micron as the support media 103, zinc particles having an average diameter of 0.1 micron as the metal adhesives 104, and a mixture of terpineol and ethyl cellulose as the organic compounds 105.

FIG. 1(b) schematically shows the state of the heat-treated nanotube paste. The organic compounds 105 are fired and disappear by a heat treatment at 450° C. for 30 minutes. The metal adhesives 104 are melted by the heat treatment and adhere the support media 103 and the nanotubes 102 onto the substrate to secure electric conduction of the support media 103 and the nanotubes 102.

An electric field is applied to the electron emitters fabricated on the glass substrate 101 to irradiate the emission electrons onto the opposite phosphor screen. The emitting pattern is then observed. The very uniform emitting pattern can be obtained. When it is observed at a micro-level, the emitting point density is above 100000 points/cm². The emitting point density can be increased by above double figures as compared with the prior art electron emitters formed by a paste using glass adhesives.

<Embodiment 2>

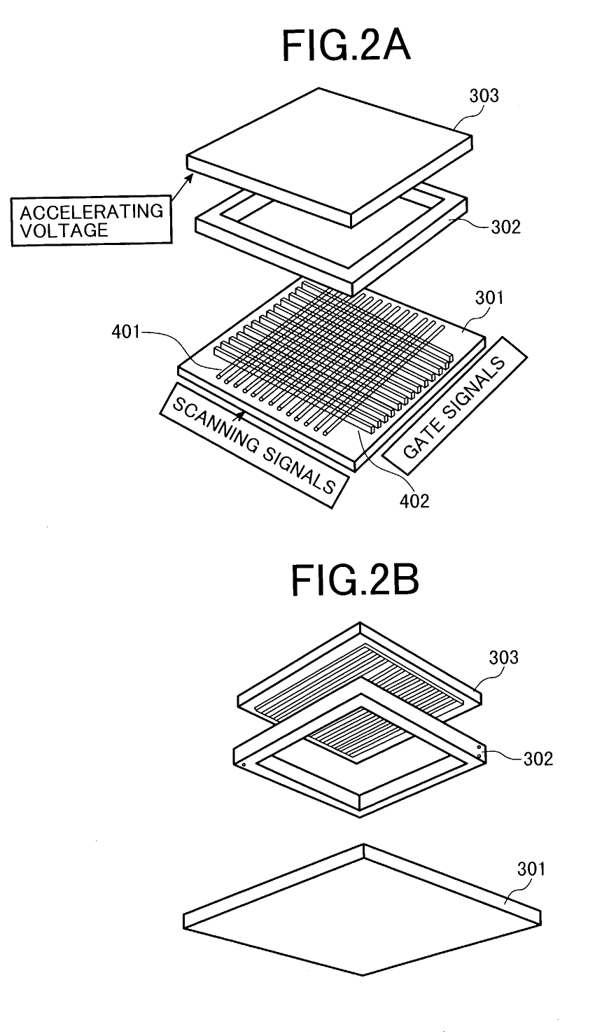

Embodiment 2 of the present invention will be described using FIGS. 2, 3, 4, 5 and 6 to 9.

Using the disassembling diagram of FIG. 2, the entire structure of an emissive type flat-panel display unit (image display panel) of the present invention will be described. FIG. 2(a) shows a perspective view looking down from slantingly above. FIG. 2(b) shows a perspective view looking up from slantingly below. The emissive type flat-panel display unit has an electron emitter substrate 301 in which electron emitter arrays are fabricated, a phosphor screen 303 in which phosphor stripes or dots are fabricated corresponding to the positions of electron emitters, and a frame glass 302 for fixing the electron emitter substrate 301 and the phosphor screen 303 at a predetermined pitch.

Although not shown, as the screen size is increased, the frame glass needs in its inside spacers for holding the electron emitter substrate 301 and the phosphor screen 303 at a predetermined pitch.

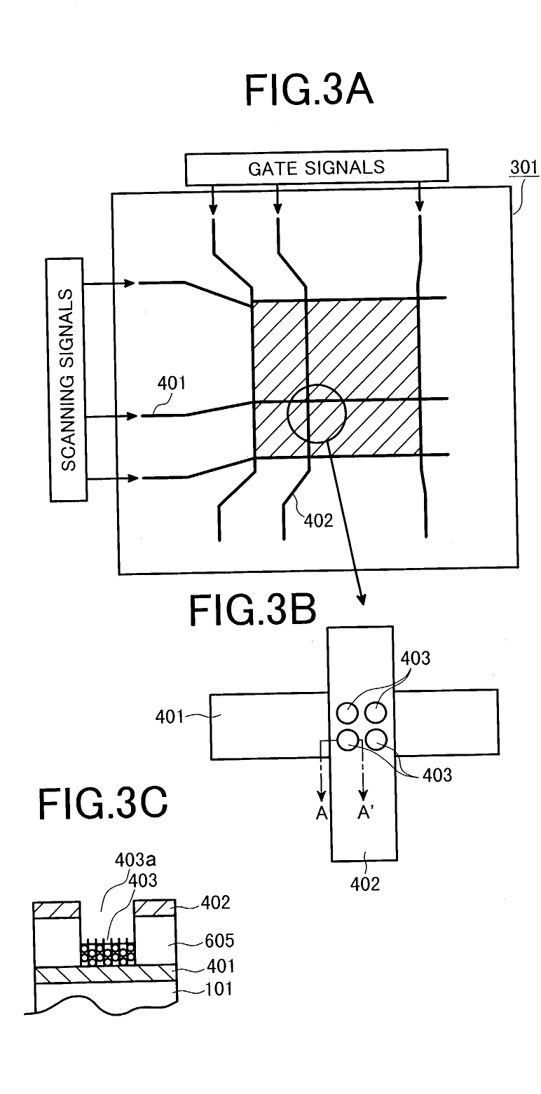

Using FIG. 3, the structure of the electron emitter substrate 301 will be described. A plurality of cathode electrode stripes 401 are formed in the horizontal direction. A plurality of gate electrode stripes 402 are formed in the vertical direction. The cathode electrode stripes 401 and the gate electrode stripes 402 cross each other by interposing a dielectric layer 605. An electron emitter 403 is formed at each of the crossing points.

FIG. 3(a) shows a plan view. FIG. 3(b) shows a partially enlarged view of the electron emitter 403 formed at the crossing point of the cathode electrode stripe 401 and the gate electrode stripe 402. FIG. 3(c) shows a partially enlarged view taken along line A-A′ of FIG. 3(b).

The electron emitter 403 is formed on the surface of the cathode electrode stripe 401 in the bottom part of an electron emitter hole 403a through the gate electrode stripe 402 and the dielectric layer 605 thereunder. The electron emitter 403 using the nanotube is formed by the method according to Embodiment 1 as described later.

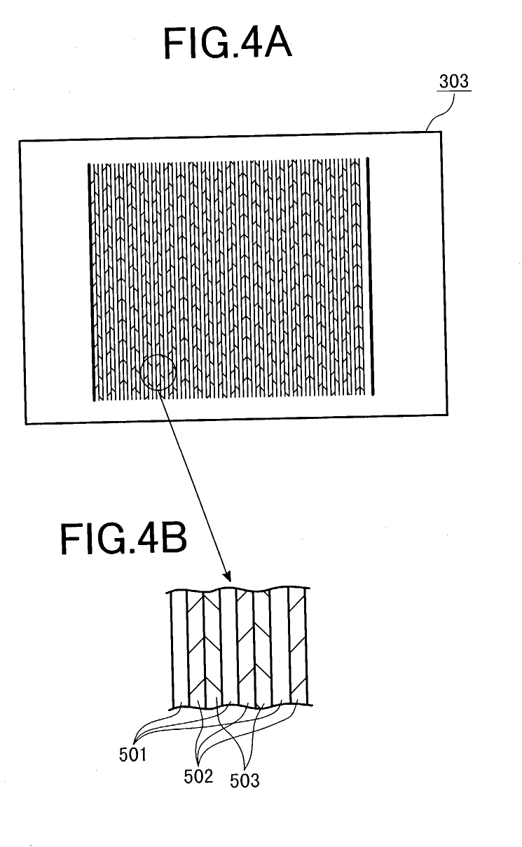

Using FIG. 4, the structure of the phosphor screen 303 will be described. FIG. 4(a) is a plan view. FIG. 4(b) is a partially enlarged view. Corresponding to the positions of the electron emitters 403, red phosphor stripes 501, green phosphor stripes 502 and blue phosphor stripes 503 are formed.

Corresponding to the horizontal pitch of the electron emitters 403 provided on the electron emitter substrate 301, black matrix stripes are fabricated by a lift-off method in regions corresponding to the center position between the electron emitters. A repeated stripe pattern of the red phosphor stripes 501, the green phosphor stripes 502 and the blue phosphor stripes 503 is formed by a slurry method.

Each of the phosphor stripes is arranged in the center of the black stripes at both sides. Although not shown, after fabricating the phosphor stripes, aluminum of 50 nm is deposited onto the entire surface to form an anode electrode.

The thus fabricated electron emitter substrate 301 and phosphor screen 303 are arranged to be opposite at a fixed pitch using the frame glass 302. After matching the positions of the electron emitters and the phosphor stripes, the display unit (image display panel) is completed by vacuum sealing its inside (see FIG. 3).

A scan signal is applied to the cathode electrode stripes 401. An image signal is applied to the gate electrode stripes 402. A plus accelerating voltage is applied to the anode electrode (not shown) of the phosphor screen 303 and the cathode electrodes 401 to display an image which is illuminated uniformly.

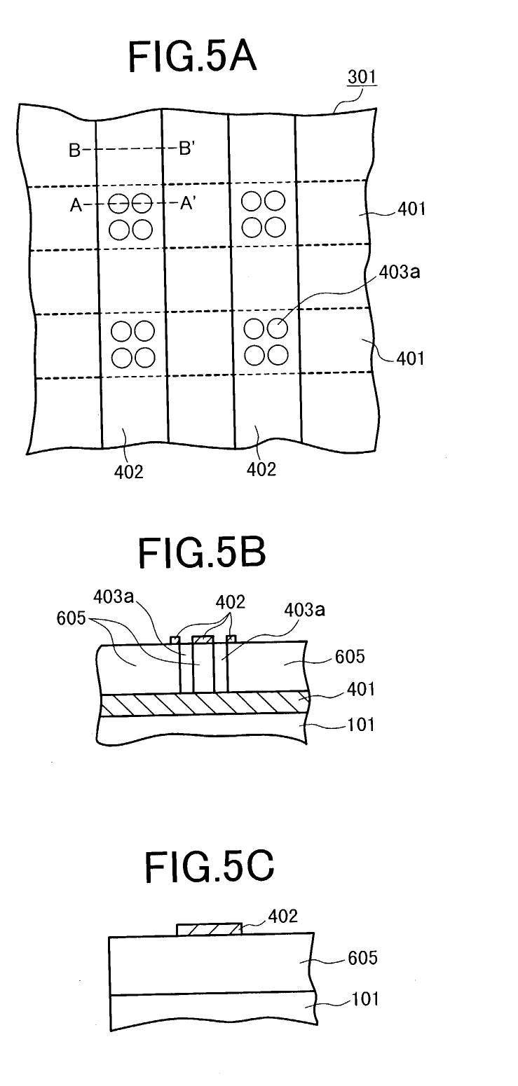

The detailed structure on the electron emitter substrate 301 will be described using FIG. 5. FIG. 5(a) is a top view. FIG. 5(b) is a cross-sectional view taken along line A-A′. FIG. 5(c) is a cross-sectional view taken along line B-B′.

First, 600 cathode electrode stripes 401 having a thickness of 0.2 to 10 um, a width of 300 um and a pitch of 60 um are formed on the surface of the glass substrate 101. The dielectric layer 605 is then formed. The dielectric layer 605 is obtained after, as described later, printing a photosensitive dielectric paste to form and fire the electron emitter holes 403a by a photolithography process.

The dielectric layer 605 has a thickness of 1 to 50 um and has the electron emitter holes 403a having a diameter of 1 to 50 um holed in the crossing parts of the cathode electrode stripes 401 and the gate electrode stripes 402. After firing the dielectric layer 605, 2400 gate electrode stripes 402 having a thickness of 0.2 to 10 um, a width of 90 um and a pitch of 30 um are formed thereon.

The gate electrode stripes 402 have the same electron source holes 403a as those of the dielectric layer 605 holed in the crossing parts of the cathode electrode stripes 401 and the gate electrode stripes 402.

Using the thus fabricated wiring structure, a scan signal is inputted to the cathode electrode stripes 401 and an image signal is inputted to the gate electrode stripes 402. An accelerating voltage is applied between the cathode electrode stripes 401 and the anode electrode, not shown, provided on the phosphor screen 303 of FIG. 4. An image which is illuminated uniformly can be displayed.

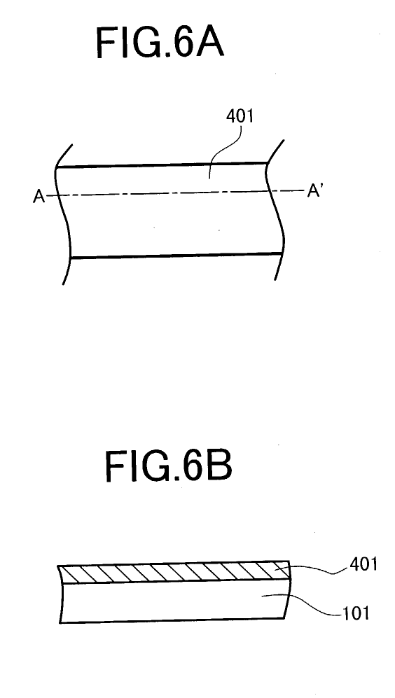

The detail of the fabrication process of the electron emitter substrate 301 will be described according to FIGS. 6 to 9. As shown in FIG. 6(a), 600 cathode electrode stripes 401 having a width of 300 um and a pitch of 60 um are formed on the glass substrate 101. The cathode electrode stripes 401 are formed by screen printing the paste shown in Embodiment 1. Their thickness is 1 um. FIG. 6(b) shows a cross-sectional view taken along line A-A′ of FIG. 6(a).

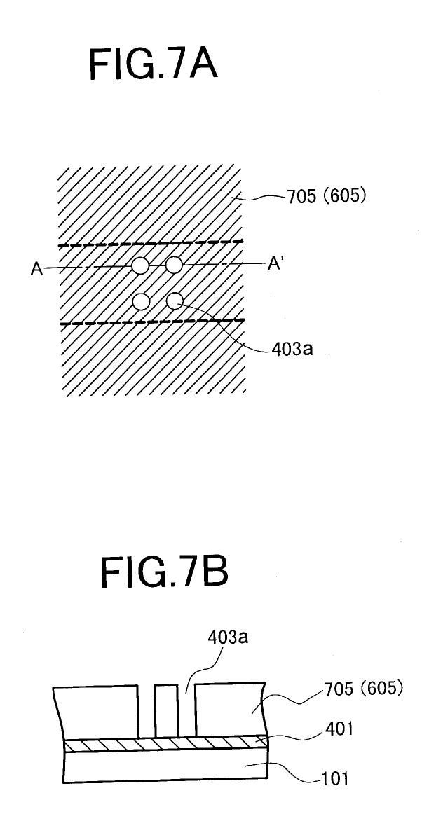

As shown in FIG. 7(a), a photosensitive dielectric paste 705 is screen printed on the entire surface to form the electron emitter holes 403a by a typical photolithography process. The same is fired in an atmosphere at 550° C. for 30 minutes to form the dielectric layer 605. The thickness of the dielectric layer 605 is 10 um.

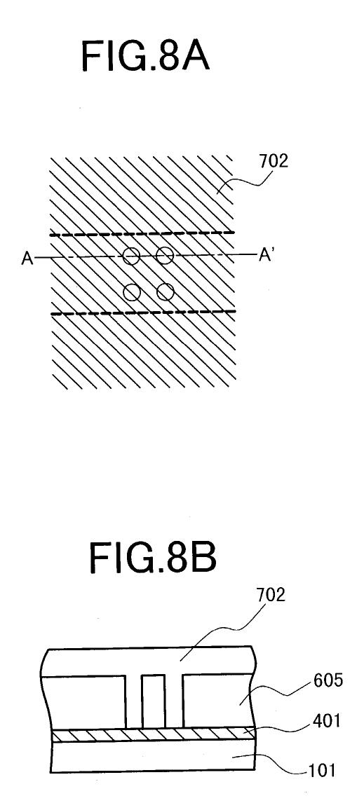

As shown in FIG. 8(a), a photosensitive Ag paste 702 is screen printed on the entire surface. FIG. 8(b) shows a cross-sectional view taken along line A-A′ of FIG. 8(a).

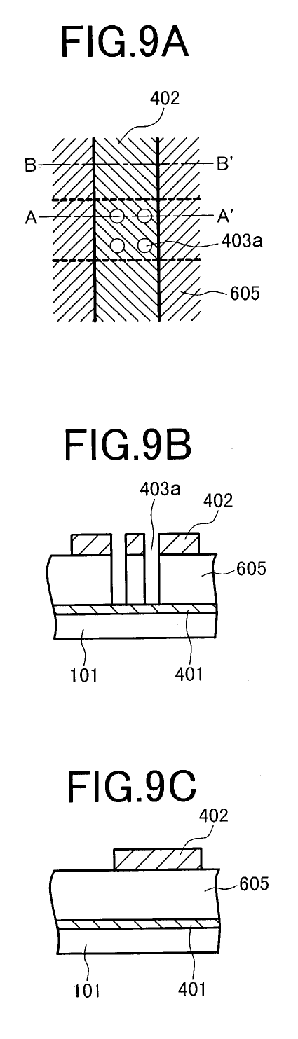

As shown in FIG. 9(a), the gate electrode stripes 402 are formed by the typical photolithography method and are fired in an atmosphere at 500° C. for 30 minutes. FIG. 9(b) shows a cross-sectional view taken along line A-A′ of FIG. 9(a). FIG. 9(c) shows a cross-sectional view taken along line B-B′ of FIG. 9(a). 2400 gate electrode stripes 402 having a width of 90 um and a pitch of 30 um are formed. The thickness of the gate electrode stripes is 5 um. The hole structures of the same size or slightly larger are formed in the same parts as those of the dielectric layer 605.

The nanotube paste is filled into the electron emitter holes 403a of the electron emitter substrate 301 formed with the cathode electrode stripes 401, the dielectric layer 605, and the gate electrode stripes 402 by a printing method to form the electrode emitters 403 by the fabrication method according to Embodiment 1.

<Embodiment 3>

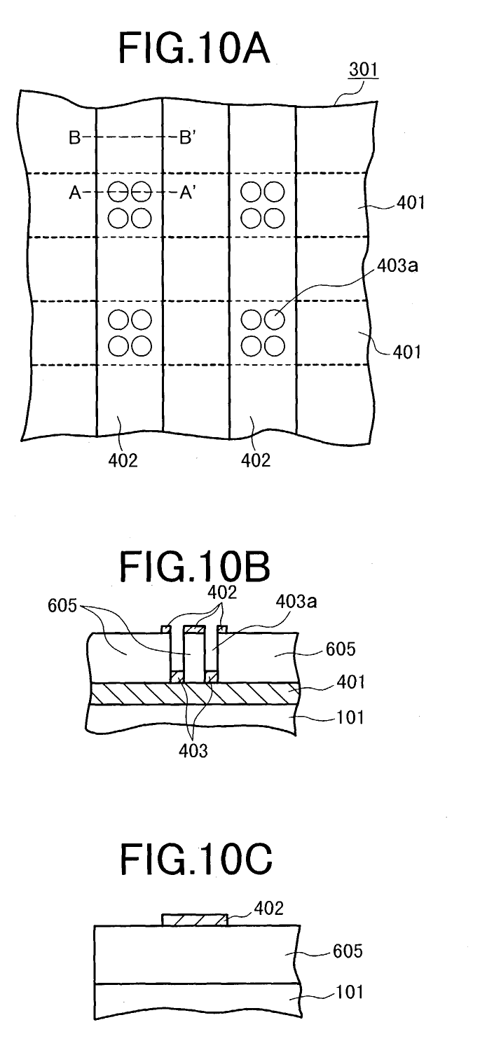

Embodiment 3 of the present invention will be described according to FIGS. 10 and 11 to 14. The structure on the electron emitter substrate 301 of this embodiment is different from that of Embodiment 2. The structure of the electron emitter substrate 301 will be described according to FIG. 10.

FIG. 10(a) is a top view. FIG. 10(b) is a cross-sectional view taken along line A-A′ of FIG. 10(a). FIG. 10(c) is a cross-sectional view taken along line B-B′ of FIG. 10(a). 600 cathode electrode stripes 401 having a thickness of 0.2 to 10 um, a width of 300 um and a pitch of 60 um are formed on the surface of the glass substrate 101.

The dielectric layer 605 is then formed. The dielectric layer 605 has a thickness of 1 to 50 um and has the electron emitter holes 403a having a diameter of 1 to 50 um holed in the crossing parts of the cathode electrode stripes 401 and the gate electrode stripes 402.

After firing the dielectric layer 605, 2400 gate electrode stripes 402 having a thickness of 0.2 to 10 um, a width of 90 um and a pitch of 30 um are formed thereon. The gate electrode stripes 402 have the same electron emitter holes 403a as those of the dielectric layer 605 holed in the crossing parts of the cathode electrode stripes 401 and the gate electrode stripes 402.

Finally, the electron emitters 403 are formed in the bottom part of the electron emitter holes 403a by the same method as that of Embodiment 2.

Using the thus fabricated wiring structure, a scan signal is inputted to the cathode electrode stripes 401 and an image signal is inputted to the gate electrode stripes 402. An accelerating voltage is applied between the cathode electrode stripes 401 and the anode electrode, not shown, provided on the phosphor screen 303 of FIG. 4. An image which is illuminated uniformly can be displayed.

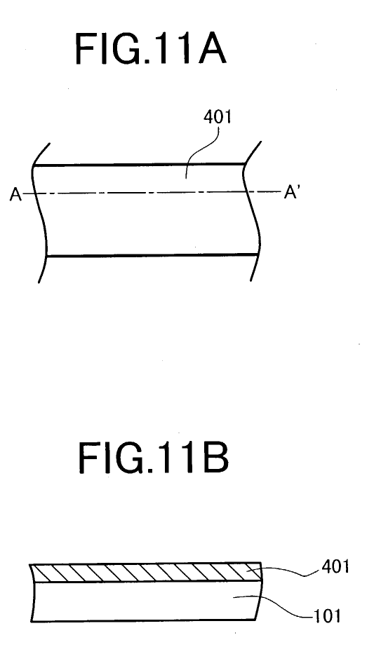

The detail of the fabrication process of the electron emitter substrate 301 will be described using FIGS. 11 to 14. As shown in FIG. 11(a), 600 cathode electrode stripes 401 having a width of 300 um and a pitch of 60 um are formed on the glass substrate 101. FIG. 11(b) shows a cross-sectional view taken along line A-A′ of FIG. 11(a). The material of the cathode electrode stripes 401 is Ag and its thickness is 1 um.

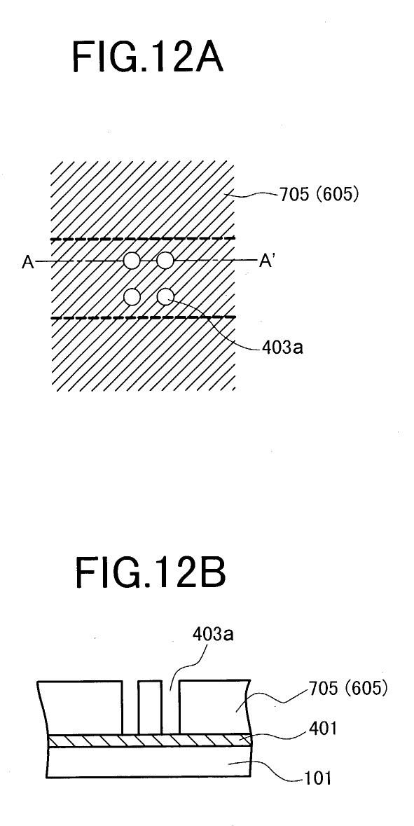

As shown in FIG. 12(a), the photosensitive dielectric paste 705 is screen printed on the entire surface to form the electron emitter holes 403a by the typical photolithography process. The same is fired in an atmosphere at 550° C. for 30 minutes to form the dielectric layer 605. The thickness of the dielectric layer 605 is 10 um.

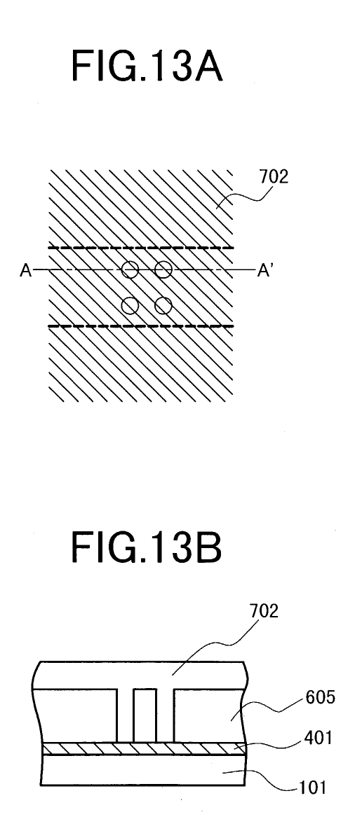

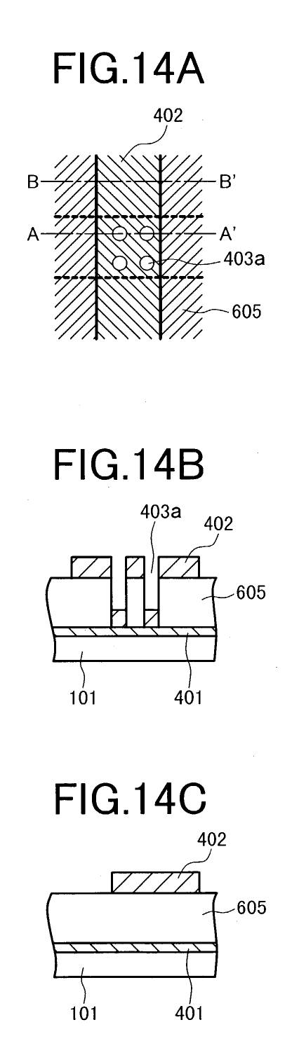

As shown in FIG. 13(a), the photosensitive Ag paste 702 is screen printed on the entire surface. FIG. 13(b) shows a cross-sectional view taken along line A-A′ of FIG. 13(a). As shown in FIG. 14(a), the gate electrode stripes 402 are formed by the typical photolithography method and are fired in an atmosphere at 500° C. for 30 minutes. FIG. 14(b) is a cross-sectional view taken along line A-A′ of FIG. 14(a). FIG. 14(c) is a cross sectional view taken along line B-B′ of FIG. 14(a).

2400 gate electrode stripes 402 having a width of 90 um and a pitch of 30 um are formed. The thickness of the gate electrode stripes is 5 um. The hole structures 403a of the same size or slightly larger is formed in the same parts as those of the dielectric layer 605.

Finally, the electron emitters 403 are formed in the bottom part of the electron emitter holes 403a by coating the nanotube paste shown in Embodiment 1 using an ink jet method.

In this embodiment, the cathode electrode stripes 401 and the gate electrode stripes 402 are formed by a specific metal. Any metal having required electric conduction can be used. An alloy and a metal multilayer film can be also used.

There is used the method for coating the carbon nanotube onto desired positions by the ink jet method. The carbon nanotube can be also arranged in the bottom part of the electron emitter holes 403a by any other method.

As described above in detail, the present invention can achieve the desired object to realize display units which can increase the emitting point density of the nanotube electron emitters as electron emitters and have a good image quality and their fabrication methods. Specifically, the emitting point density can be above 100000 points/cm². An in-plane uniform emitting pattern enough to realize the emissive type flat-panel display units can be realized.

What is claimed is:

1. A display unit comprising:
an electron emitter substrate having nanotube electron emitters as electron emitters, said electron emitters being formed in a matrix form in the crossing parts of scan lines and signal lines;
an image display panel having a phosphor screen having phosphor layers and an anode electrode arranged by forming a space at a predetermined pitch opposite said electron emitter substrate; and
a control part transmitting image information to said image display panel to display an image, wherein
in said nanotube electron emitters forming electron emitters, nanotubes and granular support media composed of an electric conductor are mixed with each other, at least one end of the nanotubes and the support media are adhered onto said substrate by melted metal adhesives, and the other end of said nanotubes is oriented as a free end in the vertical direction to the substrate by the support action of said support media.

2. The display unit according to claim 1,
wherein said granular support media are composed of a granular electric conductor not dissolved at the melting adhesion temperature of said metal adhesives.

3. The display unit according to claim 1,
wherein said metal adhesives include at least one metal selected from the metal group of Sn, Pb, Bi, In, Cd, Zn, Ag and Al.

4. The display unit according to claim 1,
wherein said granular support media are composed of at least one granular electric conductor selected from the group of C, Ag, Au, Pt, Pd, Ni, Fe, Cu and Co.

5. The display unit according to claim 1,
wherein said nanotubes include single-wall nanotubes of a single-layer tubular structure composed of at least one element of carbon, boron and nitrogen.

6. The display unit according to claim 1,
wherein said nanotubes include multiwall nanotubes of a nesting-like multilayer tubular structure composed of at least one element of carbon, boron and nitrogen.

7. The display unit according to claim 5,
wherein said single-wall nanotubes are nanotubes having an average length of 0.5 to 2.0 microns.

8. The display unit according to claim 6,
wherein said multiwall nanotubes are nanotubes having an average length of 0.5 to 5.0 microns.

9. A fabrication method of the display unit comprising:
a step of fabricating an electron emitter substrate having nanotube electron emitters as electron emitters, said electron emitters being formed in a matrix form in the crossing parts of scan lines and signal lines;
a step of fabricating a phosphor screen having phosphor layers and an anode electrode arranged by forming a space at a predetermined pitch opposite said electron emitter substrate; and
an assembling step for fixing said electron emitter substrate and said phosphor screen via a frame, wherein
said step of fabricating nanotube electron emitters forming electron emitters includes the steps of: preparing a paste including nanotubes, granular support media composed of an electric conductor, metal adhesives, and organic compounds for pasting; forming a nanotube electron emitter pattern by printing or coating said paste onto the substrate; and heat treating the same.

10. The fabrication method of the display unit according to claim 9, wherein
said metal adhesives include at least one metal selected from the metal group of Sn, Pb, Bi, In, Cd, Zn, Ag and Al,
said granular support media include at least one granular electric conductor selected from the group of C, Ag, Au, Pt, Pd, Ni, Fe, Cu and Co.
